(19) United States
(12) Patent Application Publication
(10) Pub. No.: US 2008/0055322 A1
(43) Pub. Date: Mar. 6, 2008

(54) Method and apparatus for optimizing data flow in a graphics co-processor

(76) Inventors: Thomas E. Ryan, Bolyston, MA (US); Carrell R. Killebrew, Saratoga, CA (US); Mark C. Fowler, Hopkinton, MA (US); Donald W. Cherepacha, Oakville (CA); Philip Rogers, Pepperell, MA (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/513,357

(22) Filed: Aug. 31, 2006

(51) Int. Cl. G06T 1/20

(52) U.S. Cl. 345/506

(57) ABSTRACT

A computer system includes a computer system having a system memory and a bridging device coupled to the system memory, the bridging device including a memory controller. The computer system also includes a graphics processor unit (GPU) coupled to one port of the bridging device and a central processing unit (CPU) coupled to another port of the bridging device. The GPU and the CPU access the system memory via the memory controller.

### BACKGROUND OF THE INVENTION

1. Field of the Invention

The present invention generally relates to computer systems. More particularly, the present invention relates to computer systems including graphics co-processors.

2. Related Art

Traditional computer systems, such as personal computers (PCs), include a central processing unit (CPU), system memory, a video graphics processing unit (GPU), audio processing circuitry, and peripheral ports. The CPU functions as a host processor while the GPU functions as a co-processor. In general, the CPU executes application programs and, during execution, calls upon the GPU, or co-processor, to execute particular functions. For example, if the CPU requires a drawing operation to be done, it requests the GPU to perform this drawing operation via a command through a command delivery system.

In these traditional computer systems, the CPU and the GPU are each coupled to separate dedicated memories. The CPU can be coupled to a shared system memory and the GPU will typically be coupled to a video memory, also known as a frame buffer. The frame buffer is generally an area in random access memory (RAM) that is set aside to specifically hold the data to be displayed, for example, on a video display screen.

While providing separate memories for the CPU and the GPU has many advantages, one significant challenge is providing sufficient power for both memories, especially in laptop computers. Therefore, to save power, a recent trend in computer system design includes omitting the use of dedicated frame buffers. Instead, a single system memory is shared between the CPU and the GPU. A bridging device, such as a north bridge, acts as a host/PCI bridge between the GPU, the CPU, and the single system memory. As understood by those of skill in the art, a north bridge is system logic circuitry that enables the CPU and the GPU to effectively share a single system memory. In other words, the north bridge establishes communication paths between the CPU, the system memory, and the GPU.

Of the many communications paths established by the north bridge, one path of particular interest is the path between the north bridge and the GPU. In many computer systems, the communications path between the north bridge and the GPU is narrower and farther away than typical GPU/memory interface paths. Because of this, the communications path between the north bridge and the GPU imposes significant data flow constraints. These data flow constraints, or choke points, can severely cripple the system's throughput.

What is needed, therefore, is a method and apparatus to reduce the data flow constraints imposed by the communications path between the bridging device and the GPU.

### BRIEF SUMMARY OF THE INVENTION

Consistent with the principles of the present invention as embodied and broadly described herein, the present invention includes a computer system having a system memory and a bridging device coupled to the system memory, the bridging device including a memory controller. The computer system also includes a graphics processor unit (GPU) coupled to one port of the bridging device and a central processing unit (CPU) coupled to another port of the bridging device. The GPU and the CPU access the system memory via the memory controller.

Further embodiments, features, and advantages of the present invention, as well as the structure and operation of the various embodiments of the present invention, are described in detail below with reference to the accompanying drawings.

### BRIEF DESCRIPTION OF THE DRAWINGS

The accompanying drawings, which are incorporated in and constitute part of the specification, illustrate embodiments of the invention and, together with the general description given above and the detailed description of the embodiment given below, serve to explain the principles of the present invention. In the drawings:

FIG. 1 is block diagram illustration of a conventional computer system used in graphics applications;

FIG. 1A is a block diagram illustration of a conventional computer system used in graphics applications that excludes a dedicated frame buffer memory;

FIG. 2 is a block diagram illustration of a computer system constructed in accordance with a first embodiment of the present invention;

FIG. 3 is a block diagram illustration of a computer system constructed in accordance with a second embodiment of the present invention; and

FIG. 4 is a flow diagram of an exemplary method of practicing the present invention.

### DETAILED DESCRIPTION OF THE INVENTION

The following detailed description of the present invention refers to the accompanying drawings that illustrate exemplary embodiments consistent with this invention. Other embodiments are possible, and modifications may be made to the embodiments within the spirit and scope of the invention. Therefore, the detailed description is not meant to limit the invention. Rather, the scope of the invention is defined by the appended claims.

It would be apparent to one of skill in the art that the present invention, as described below, may be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, given the level of detail presented herein.

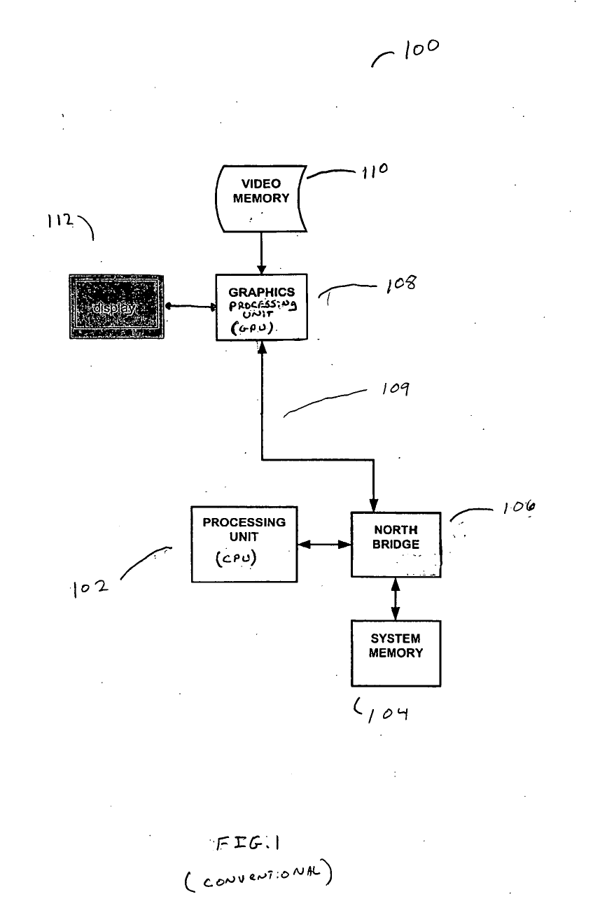

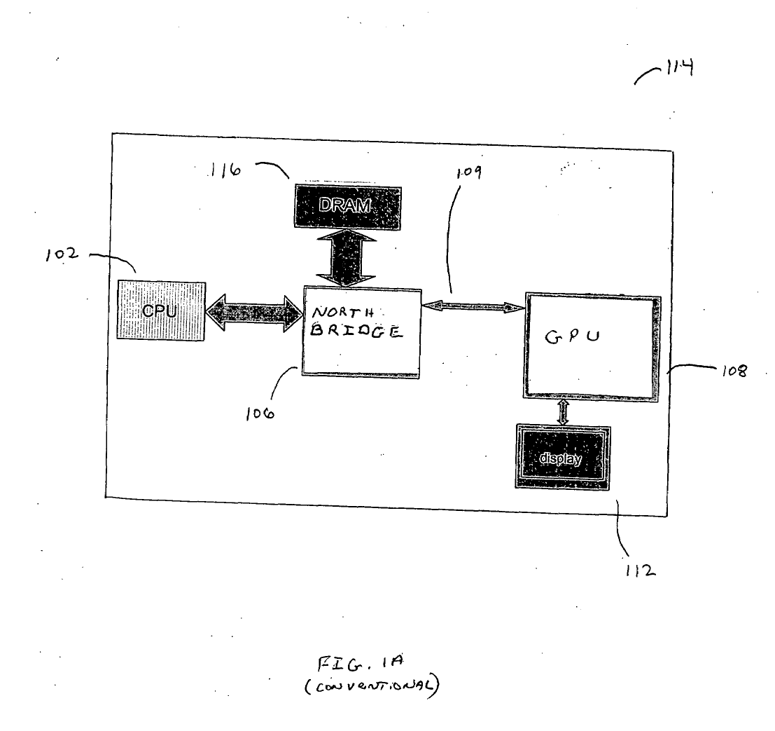

FIG. 1 is block diagram illustration of a conventional computer system 100 used in graphics applications. The conventional computer system 100 includes a CPU 102, a dynamic RAM (DRAM) 104, a north bridge 106, and a GPU 108. The CPU 102 and the DRAM 104 are operatively coupled to a bridging device, such as the north bridge 106. As noted above, the north bridge 106 operates as a host/PCI bridge and provides communication paths between the CPU 102, the DRAM 104, and the GPU 108. The north bridge 106 is coupled to the GPU 108 along a communications path 109.

FIG. 1 also illustrates that the GPU 108 is coupled to a dedicated video memory 110, which can be a frame buffer memory. Data stored within the video memory 110 (frame buffer) is displayed on a display device 112, such as a computer screen.

One of the challenges associated with traditional computer systems, such as the system 100, is that having separate memories for the CPU 102 and the GPU 108 creates a higher overall system cost. An additional consideration in lap top computers, for example, is that separate memories require more battery power. Therefore, from a cost and power savings perspective, a more efficient memory configuration is one where a single system memory, which consumes less power than multiple memories, is shared between the CPU and the GPU.

FIG. 1A is a block diagram illustration of a computer system 114 where a single system memory is shared between the CPU and the GPU. In FIG. 1A, a single system memory (e.g., a number of DRAM chips) 116 is shared between the CPU 102 and the GPU 108, via the north bridge 106. The communications path 109 provides an interface between the GPU 108 and the north bridge 106. However, with only the single system memory 116, the data handling capability of the GPU 108 becomes limited by the throughput of the communications path 109.

Most modern source material, such as high definition (HD) video, is data intensive, thereby requiring the use of significant amounts of memory. When available communications channels between the processor and memory, such as the communications path 109, are bandwidth limited, this HD video material cannot be successfully viewed. For example, the communications path 109 may be so constrained that sufficient amounts of data cannot travel fast enough to update the display 112 during a HD video presentation. This issue arises because essentially all data must travel back and forth between the GPU 108 and the DRAM 116, across the communications path 109.

For example, when a standard graphics operation is performed within the GPU 108, data must first be read from the memory 116. This data must travel from the memory 116, across the communications path 109, to the GPU 108. The GPU 108 then operates upon or manipulates the data, sends and then returns the data across the communications path 109 for storage in the memory 116. This continuing bi-directional movement of data between the GPU 108 and the single system memory 116 is necessary because the GPU 108 does not have its own dedicated frame buffer. Thus, the system 114 suffers in performance due to the constraints of the communications path 109.

The bandwidth of the communications path 109 is essentially a fixed amount, typically about 3 giga-bytes per second in each direction. Absolute bandwidth values will rise and fall over time, but so will the demand (i.e. run faster, more complex processing, higher resolutions). This rising and falling of bandwidth demand averages out to an equivalent of the fixed bandwidth value discussed above.

This fixed bandwidth value is established by the form factor of the PC and is an industry standard. As understood by those of skill in the art, this industry standard is provided to standardize the connectivity of plug and play modules. Although the PC industry is trending towards a wider bandwidth standard, today's standard imposes significant throughput constraints. In a general sense, however, By way of background, it is known to those of skill in the art that

Because of the throughput constraints between the GPU 108 and the north bridge 106, the ability of the GPU 108 to perform specific video functions consequently becomes constrained. That is, certain graphics functions within the GPU 108 simply cannot be accomplished due to the throughput constraints of the communications channel 109.

For example, generally, graphics functions (i.e., 3D operations) will continue to function correctly, but may have degraded performance (i.e. games will be sluggish). Video processing requires real-time updates and can therefore fail. A latency issue also exists. That is, because of the use of a single system memory, memory data may be farther from GPU. Therefore, instances can arise where the GPU will stall waiting for the data. This stalling, or latency, is especially problematic for display data and can also impact general system performance.

Although conventional techniques exist that try to limit the performance impact of longer latencies, these conventional techniques add cost to the GPU and aren't particularly effective. One such technique is known in the art includes the use of an integrated graphics device. These integrated graphics devices, however, are typically optimized to minimize costs. In many cases, because costs are the primary concern, performance and efficiency suffer. Therefore, a more efficient technique is needed to optimize the flow of data within the computer system 114.

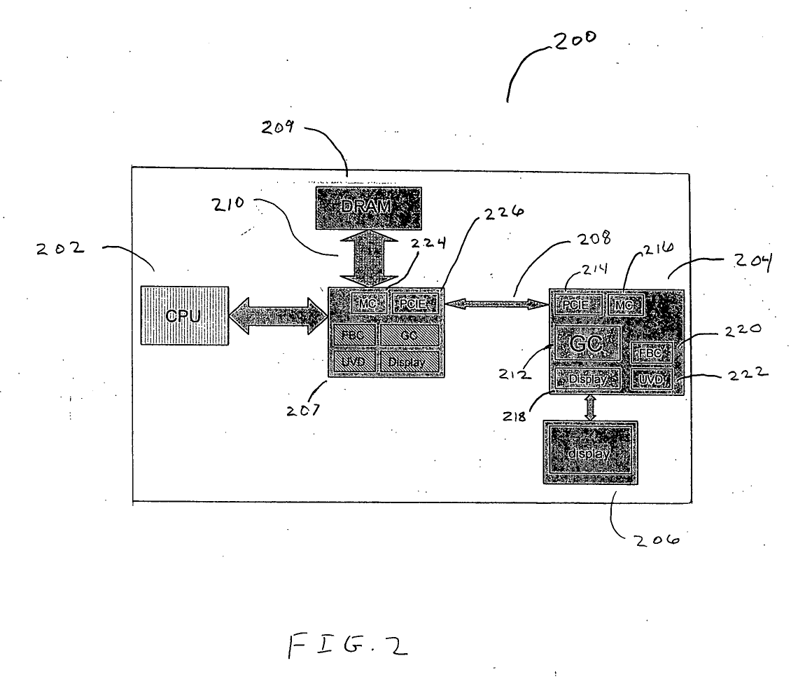

FIG. 2 is a block diagram illustration of a computer system 200 implemented in accordance with a first embodiment of the present invention. The computer system 200 includes a CPU 202, a graphics controller chip (i.e., GPU) 204, a display screen 206, and a north bridge 207. A first communications path 208 provides an interface between the GPU 204 and the north bridge 207. The data flow between the GPU 204 and the north bridge 207 is optimized by redistributing its flow between the GPU 204 and the north bridge 207. More specifically, an apriori determination is made whether functions to be performed on the data should be performed (i.e., partitioned) within the GPU 204 or within the north bridge 207. By carefully partitioning functionality and/or functional modules between the GPU 204 and the north bridge 207, the need for certain data to travel across the first communications path 208 can be eliminated.

In addition to the components noted above, the computer system 200 also includes a single system memory, such as a DRAM 209. Although in the embodiment of FIG. 2, the system memory 209 is illustrated as being implemented as DRAM, the memory can be any one of a number of other suitable memory types, such as static RAM (SRAM), as one example.

The GPU 204 and the north bridge 207 each includes predetermined functional modules that are configured to perform specific operations upon the data. Application drivers (not shown), executed by the CPU 202, can be programmed to dynamically control which functional modules are to be enabled within, or partitioned between, the GPU 204 and the north bridge 207. Within this framework, a user can determine, for example, that support functionality modules will be enabled within the north bridge 207 and graphics functionality modules will be enabled within the GPU 204. As a practical matter, the functions distributed between the GPU 204 and the north bridge 207 in the computer system 200 can be combined into a single integrated circuit (IC). Better performance, however, is achieved within the computer system 200 by dividing the functions across separate ICs.

Fundamentally, the ability to redistribute functions between the GPU 204 and the north bridge 207 is based upon the fact that data processing functions work as a memory-to-memory operation. That is, input data is read from a memory, such as the DRAM 209, and processed by a functional module, discussed in greater detail below. The resulting output data is then written back to the DRAM 209. In the present invention, therefore, whenever a functional module operates upon a specific portion of data within the north bridge 207 rather than in the GPU 204, this portion of data is no longer required to travel from the north bridge 207 to the GPU 204, and back. Stated another way, since this portion of data is processed within north bridge 207, it no longer needs to travel across the first communications path 208.

The first communications path 208 is also representative of a virtual channel formed between the GPU 204 and the north bridge 207. That is, the first communications path 208 can be logically divided into multiple virtual channels. A virtual channel is used to provide dedicated resources or priorities to a set of transactions or functions. By way of example, a virtual channel can created and dedicated to display traffic. Display is critical since the display screen 206 is desirably refreshed about 60 or more times per seconds. If the display data is late, the displayed images can be corrupted or may flicker. Using a virtual channel helps provide dedicated bandwidth and latency for display traffic.

Also in the computer system 200, a second communications path 210 provides an interface between the north bridge 207 and the DRAM 209. As noted above, the north bridge 207 and the GPU 204 each includes functional modules configured to perform predetermined functions on data stored within the DRAM 209. The specific types of functions performed by each of the functional modules within the GPU 204 and the north bridge 207 are not significant to operation of the present invention. However, for purposes of illustration, specific functions and functional modules are provided within the computer system 200, as illustrated in FIG. 2, to more fully describe operation of the present invention.

For example, functional modules included within the GPU 204 include a graphics core (GC) 212 for performing 3-dimensional graphics functions. A peripheral component interconnect express (PCIE) interface 214 is used to decode protocols for data traveling from the north bridge 207 to a standard memory controller (MC) 216, within the GPU 204. A display block 218 is used to push data, processed within the GPU 204, out to the display screen 206. A frame buffer compression (FBC) module 220 is provided to reduce the number of internal memory accesses in order to conserve system power. In the exemplary embodiment of FIG. 2, however, the FBC 220 is not enabled. Finally, a universal decoder (UVD) module 222 is configured to decode and play HD video. The present invention, however, is not limited to the specific functional modules illustrated in FIG. 2. For example, other functional modules might include simple video processors, accelerators, 3D components, compression/decompression blocks, and/or security blocks such as encryption/decryption, to name a few.

Similar functional modules are included within the north bridge 207 and operate essentially the same as those included within the GPU 204. Thus, the description of these similar functional modules will not be repeated. A memory controller 224 and a PCIE interface 226 are provided to encode data traveling from the north bridge 207 to the GPU 204. In the embodiment of FIG. 2, the functions of the PCIE interface 214 and the MC 216 are asymmetrical to functions of the PCIE interface 226 and MC 224.

As discussed above, the present invention optimizes the flow of data between the GPU 204 and the north bridge 207 by redistributing its flow. For example, assume that an instruction has been forwarded via the CPU 202 to perform a graphics core function upon data stored within the DRAM 209. In a conventional computer system arrangement, the graphics core function might be performed within the GPU 204. In the present invention, however, an apriori determination can be made to enable the GC function within the north bridge 207 instead of the GPU 204.

The north bridge 207 will likely require less power to do the processing since data is not passed through the north bridge 207, across the communications path 208, and into the GPU 204. High bandwidth links consume relatively high amounts of power. If the computer system 200 can be configured to require less bandwidth, the communication links, such as the communications path 208, can be placed into a lower power state for greater periods of time. This lower power state helps conserve power.

The apriori determination to enable the GC function within the north bridge 207 instead of the GPU 204 can be implemented by configuring associated drivers executed by the CPU 202 using techniques known to those of skill in the art. In this manner, whenever the GC function is required, data will be extracted from the DRAM 209, processed within the GC functional module within the north bridge 207, and then stored back into the DRAM 209. Data processing within the north bridge 207 precludes the need for shipping the data across the communications path 208, thus preserving the use of this path for other system functions.

For highest performance, as an example, the computer system 200 can be configured to use all functional modules in both GPU 204 and the north bridge 207 simultaneously. Configuring the computer system 200 in this manner requires a balancing between bandwidth and latency requirements. For example, processing intensive tasks that might require lower bandwidths, can be placed on the GPU 204. Low latency tasks that might require higher bandwidths, can be placed on the north bridge 207.

By way of illustration, when the computer system 200 is placed in operation, a user can be presented via the display screen 206 with an option of selecting an enhanced graphics mode. Typical industry names for enhanced graphics modes include, for example, extended 3D, turbo graphics, or some other similarly name. When the user selects this enhanced graphics mode, the drivers within the CPU 202 are automatically configured to optimize the flow of data between the north bridge 207 and the GPU 204, thus enabling the graphics enhancements.

More specifically, when an enhanced graphics mode is selected by the user, the drivers within the CPU 202 dynamically configures the functional modules within north bridge 207 and the GPU 204 to maximize the number of data processing functions performed within the north bridge 207. This dynamically configured arrangement minimizes the amount of data requiring travel across the communications path 208. In so doing, bandwidth of the communications path 208 is preserved and its throughput is maximized.

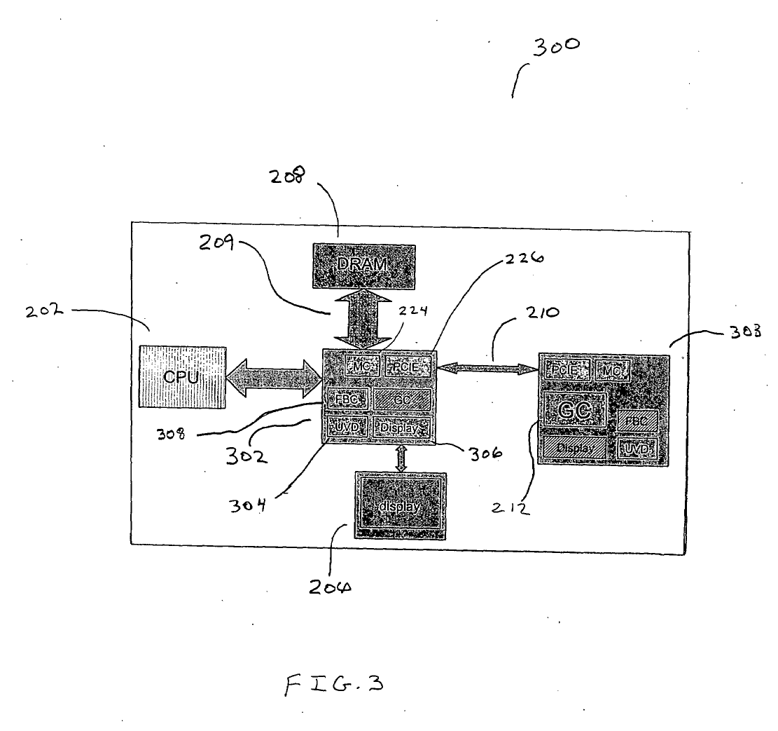

FIG. 3 is a block diagram illustration of a graphics computer system 300 arranged in accordance with a second embodiment of the present invention. The computer system 300 of FIG. 3 is similar to the computer system 200 of FIG. 2. The computer system 300, however, includes the display screen 206 coupled directly to a north bridge 302. Also included in the computer system 300 is a GPU 303.

The computer system 300, among other things, addresses a separate real-time constraint issue related to display screen data refresh. That is, typical computer system displays are refreshed at a rate of at least 60 times per second, as noted above. Therefore, if the display data cannot travel across the communications path 208 in a manner supportive of this refresh rate, images being displayed on the display screen 206 can become distorted or flicker. Thus, the embodiment of FIG. 3 represents another exemplary technique, in addition to the virtual channel and redistributing function, for managing data flow between a north bridge and a GPU.

Correspondingly, as discussed above in relation to FIG. 2, functional modules within the north bridge 302 and the GPU 303 are enabled to optimize data flow across the communications path 208. For example, in the computer system 300, a UVD functional module 304, a display module 306, and FBC module 308 are activated to support the direct coupling of the display screen 206 to the north bridge 302. Thus, in the computer system 300, data that would have traveled across the communications path 208 for processing within the GPU 303, can now remain within the north bridge 302.

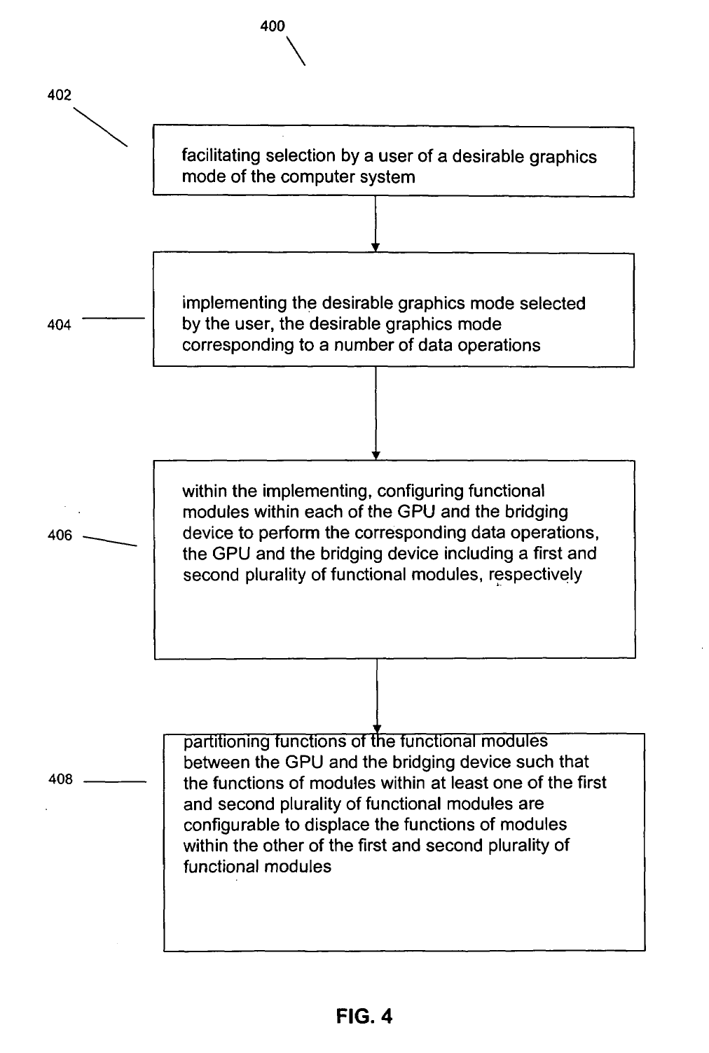

FIG. 4 is a flow diagram of an exemplary method 400 of practicing the present invention. In FIG. 4, a user selects a desirable graphics mode of the computer system, as indicated in step 402. In step 404, the desirable graphics mode selected by the user is implemented, the desirable graphics mode corresponding to a number of data manipulation functions applications. As indicated in step 406, the implementing includes configuring functional modules within each of the GPU and the bridging device to perform the corresponding data operations, the GPU and the bridging device including a first and second plurality of functional modules, respectively. Finally, functional modules within the GPU and the bridging device are partitioned such that the data operations of modules within at least one of the first and second plurality of functional modules are configurable to displace the data operations of modules within the other of the first and second plurality of functional modules, as indicated in step 408.

### CONCLUSION

The present invention provides a technique and a computer system to reduce the throughput constraints imposed by a communications path between a bridging device and a GPU. By carefully partitioning functionality and/or functional modules between the GPU and the bridging device, the need for certain data to travel across a narrow communications path between the GPU and the bridging device can be eliminated, thus increasing overall system throughput.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What we claim is:

1. A computer system comprising:
a system memory;
a bridging device coupled to the system memory and including a memory controller;
a graphics processor unit (GPU) coupled to one port of the bridging device; and
a central processing unit (CPU) coupled to another port of the bridging device;
wherein the GPU and the CPU access the system memory via the memory controller.

2. The computer system of claim 1, wherein the system memory is dynamic read and write memory.

3. The computer system of claim 2, wherein the bridging device is a north bridge.

4. The computer system of claim 3, wherein the GPU is devoid of a frame buffer memory.

5. The computer system of claim 4, wherein the GPU includes a first plurality of functional modules configured to receive data from the system memory.

6. The computer system of claim 5, wherein the bridging device is (i) coupled between the system memory and the GPU along a data path and (ii) includes a second plurality of functional modules.

7. The computer system of claim 6, wherein functions of modules within at least one of the first and second plurality of functional modules are configurable to displace functions of modules within the other of the first and second plurality of functional modules.

8. A computer system, comprising:
a system memory for storing data;
a graphics processor unit (GPU) including a first plurality of functional modules configured to receive the data from the system memory; and
a bridging mechanism (i) being coupled between the system memory and the GPU along a data path and (ii) including a second plurality of functional modules;
wherein functions of modules within at least one of the first and second plurality of functional modules are configurable to displace functions of modules within the other of the first and second plurality of functional modules.

9. The computer system of claim 8, further comprising a display coupled to the GPU and configured to display the received data.

10. The computer system of claim 8, wherein the memory is a random access memory (RAM).

11. The computer system of claim 10, wherein the RAM is at least one of a static RAM and a dynamic RAM.

12. The computer system of claim 8, wherein the graphics processor is devoid of a dedicated graphics memory.

13. The computer system of claim 8, wherein the graphics processor is devoid of a frame buffer.

14. The computer system of claim 8, wherein the bridging mechanism manages access to the system memory by the GPU and a central processing unit (CPU).

15. The computer system of claim 8, wherein displacing includes matching and replacing the functions.

16. The computer system of claim 8, wherein the displacing optimizes an amount of data traffic along the data path.

17. The computer system of claim 8, wherein the bridging mechanism is a north bridge device.

18. A method for reducing traffic across a communications channel in a computer system, the communications channel being between a bridging device and a graphics processing unit (GPU), a system memory being coupled to the bridging device, wherein the bridging device is connected between the GPU, the system memory, and a central processing unit (CPU), the method comprising:
facilitating selection by a user of a desirable graphics mode of the computer system; and
implementing the desirable graphics mode selected by the user, the desirable graphics mode corresponding to a number of data operations;
wherein the implementing includes configuring functional modules within each of the GPU and the bridging device to perform the corresponding data operations, the GPU and the bridging device including a first and second plurality of functional modules, respectively; and
wherein functions of the functional modules are partitioned between the GPU and the bridging device such that the functions of modules within at least one of the first and second plurality of functional modules are configurable to displace the functions of modules within the other of the first and second plurality of functional modules.

19. The method of claim 18, wherein displacing includes matching and replacing the functions.

20. The method of claim 19, wherein the displacing reduces data traffic along the data path.

21. The method of claim 19, further comprising coupling a display device to the graphics bridging device.

22. The method of claim 19, wherein the data is video data.

23. An apparatus for reducing traffic across a communications channel in a graphics system, the communications channel being between a graphics bridging device and a graphics processing unit (GPU), a system memory being coupled to the graphics bridging device, the bridging device being connected between the GPU, the system memory and a central processing unit (CPU), the apparatus comprising:
means for facilitating selection by a user of a desirable graphics mode of the computer system; and
means for implementing the desirable graphics mode selected by the user, the desirable graphics mode corresponding to a number of data manipulation functions applications;
wherein the implementing includes configuring functional modules within each of the GPU and the bridging device to perform the corresponding data operations, the GPU and the bridging device including a first and second plurality of functional modules, respectively; and
wherein functions of the functional modules are partitioned between the GPU and the bridging device such that the data operations of modules within at least one of the first and second plurality of functional modules are configurable to displace the data operations of modules within the other of the first and second plurality of functional modules.
